(19) United States
(12) Patent Application Publication
(10) Pub. No.: US 2010/0169831 A1
(43) Pub. Date: Jul. 1, 2010

(54) Information Product and Method for Interacting with User

(75) Inventor: Tsung-Yi Lu, Taoyuan City (TW)

Correspondence Address: THOMAS, KAYDEN, HORSTEMEYER & RISLEY, LLP, 600 GALLERIA PARKWAY, S.E., STE 1500, ATLANTA, GA, 30339-5994, US

(73) Assignee: HTC CORPORATION, Taoyuan City (TW)

(21) Appl. No.: 12/649,554

(22) Filed: Dec. 30, 2009

(30) Foreign Application Priority Data
Dec. 31, 2008 (TW) 97151695

(51) Int. Cl. G06F 3/048; H04M 1/00

(52) U.S. Cl. 715/810; 455/556.2; 715/853

(57) ABSTRACT

Disclosed are a method for displaying tree structure data and a hand-held electronic device and a computer program product thereof, wherein the tree structure data includes a node item and a sub-item and the sub-item is belong to the node item. The hand-held electronic device includes a menu providing module, a tag providing module, an input module, and a display module. In the method for displaying tree structure data, an item line including the sub-item and a tag item are initially displayed on a screen. Thereafter, the tag item is moved. When the tag item is next to the sub item, the name of the node item is displayed on the screen. A computer performs the method for displaying tree structure data by loading the computer program product.

### RELATED APPLICATIONS

This application claims priority to Taiwan Application Serial Number 97151695, filed Dec. 31, 2008, which is herein incorporated by reference.

### FIELD OF THE INVENTION

A method for displaying tree structure data and a hand-held electronic device and a computer program product thereof are disclosed, and more particularly, to a hand-held electronic device with a screen, a method for displaying tree structure data on a hand-held electronic device, and a computer program product of the method.

### BACKGROUND OF THE INVENTION

Hand-held electronic devices, and in particular hand-held communication devices, are widely used in daily life and greatly influence the lives of people. To meet different functional demands hand-held communication devices have become smaller and have more functions. The hand-held communication devices, for example personal digital assistant (PDA) phones and smart phones, not only have the traditional communication device functions, but also provide a built-in operating system to perform advanced functions, such as document writing, e-mail transmitting and receiving, internet browsing, and instant messaging software. In other words, the hand-held communication device can not only be used as a telephone, but can also be used as small personal computers with multiple functions. In addition, because of the development of wireless network technology, it is possible to use the hand-held communication devices to perform advanced functions anytime and anywhere. Therefore, hand-held electronic devices have become necessary for modern people who place a great emphasis on time management and efficiency.

Refer to FIG. 1 and FIG. 2 simultaneously. FIG. 1 is a structure diagram showing a function menu 10 with a tree structure. FIG. 2 is a structure diagram showing a function menu interface implemented on a conventional hand-held device to display the function menu 10. The function menu 10 includes node items 12 and sub-items 14. Each node item 12 includes at least one of the sub-items 14. In general, data stored in an electronic device, such as node items 12 and sub-items 14, is usually arranged in a tree structure form because the tree structure form makes data easily and quickly comprehended by users. In hand-held electronic devices, each of the node items and sub-items corresponds to an option. For example, a node item 12 corresponds to a function for displaying the content of “Chapter 2: overview of the SE-CMM”.

In a personal computer, the node items 12 and sub-items 14 are usually displayed in a hierarchical way, and the way used by the hand-held electronic device to display the node items 12 and sub-items 14 is the same as that used by a personal computer. Because of the limited size of the hand-held electronic device, the size of the icon of each of the options must be smaller when the options are displayed on the limited screen area of the hand-held electronic device in the hierarchical way. However, if the icon is made too small, the user may not see the name of the option clearly, or the users may easily select the incorrect causing frustration and wasting time.

### SUMMARY OF THE INVENTION

A hand-held electronic device is provided. The menu interface of the hand-held electronic device can display icons of options with the normal size to help users easily select the correct option and enable users to easily read the names of the options on the screen.

An exemplary method for displaying tree structure data and a computer program product thereof is provided. A menu interface set up via the method can display normal sized icons for the different options to help users easily select the correct option and enable users to easily read the names of the options on the screen.

According to another exemplary hand-held electronic device, the hand-held electronic device includes a menu providing module, a tag providing module, an input module, and a display module. The menu providing module is used to provide tree structure data, wherein the tree structure data includes a node item and a sub-item belong to the node item. The tag providing module is used to provide a tag item and move the tag item. The input module is used to be inputted a control signal by a user to control the tag providing module, wherein the tag providing module moves the tag item in accordance with the control signal. The display module is used to display at least one portion of an item line comprising the node item and the sub-item on the screen. The screen shows the name of the node item when the user moves the tag item to an area next to the sub item.

According to another exemplary method for the displaying tree structure data, at least one portion of an item line including the sub-item and a tag item is firstly displayed on a screen. Then, the tag item is moved. Thereafter, the name of the node item is displayed, when the tag item is next to the sub item.

According to an exemplary computer program product, the computer program product can be loaded by a computer to enable the computer to display the tree structure data.

### BRIEF DESCRIPTION OF THE DRAWINGS

The foregoing aspects and many of the attendant advantages of this disclosure will become more readily appreciated as the same becomes better understood by reference to the following detailed description, when taken in conjunction with the accompanying drawings, wherein:

FIG. 1 is a structure diagram showing a function menu with a tree structure;

FIG. 2 is a structure diagram showing a function menu interface used implemented on a conventional hand-held device to display the function menu;

FIG. 3 is a flow chart showing an exemplary method to display the tree structure data;

FIG. 4 to FIG. 6 are diagrams showing the screen of an exemplary hand-held electronic device;

FIG. 7 is a flow chart showing an exemplary method for displaying the tree structure data;

FIG. 11 is a functional block diagram showing an exemplary hand-held electronic device; and

FIG. 12 is a functional block diagram showing an exemplary hand-held electronic device.

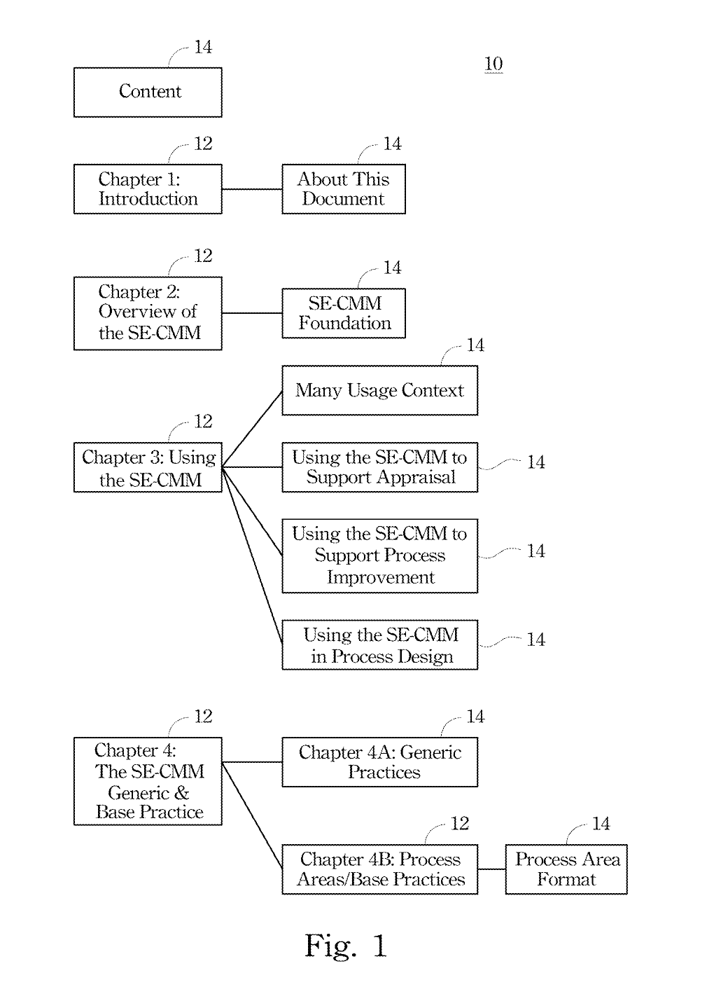

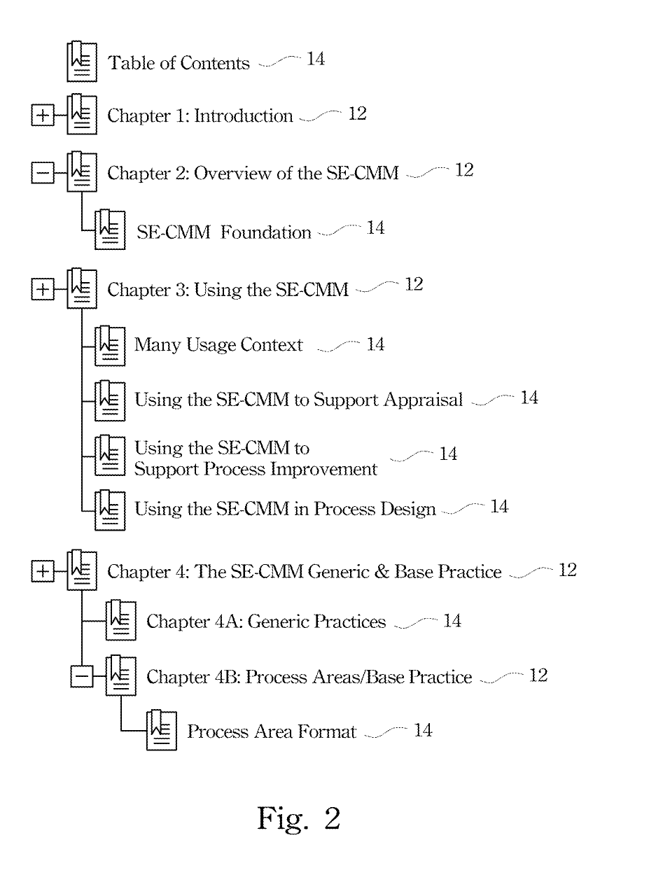

### DETAILED DESCRIPTION

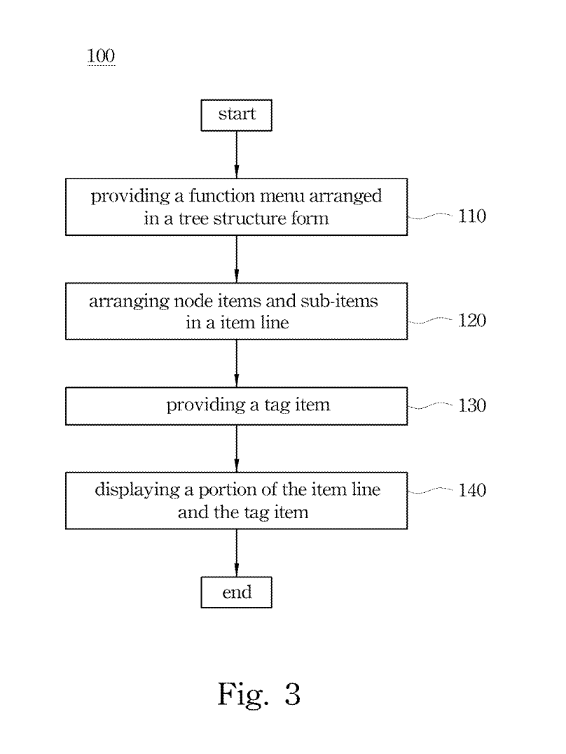

In order to make the illustration of the present disclosure more explicit and complete, the following description is stated with reference to FIG. 3 through FIG. 12.

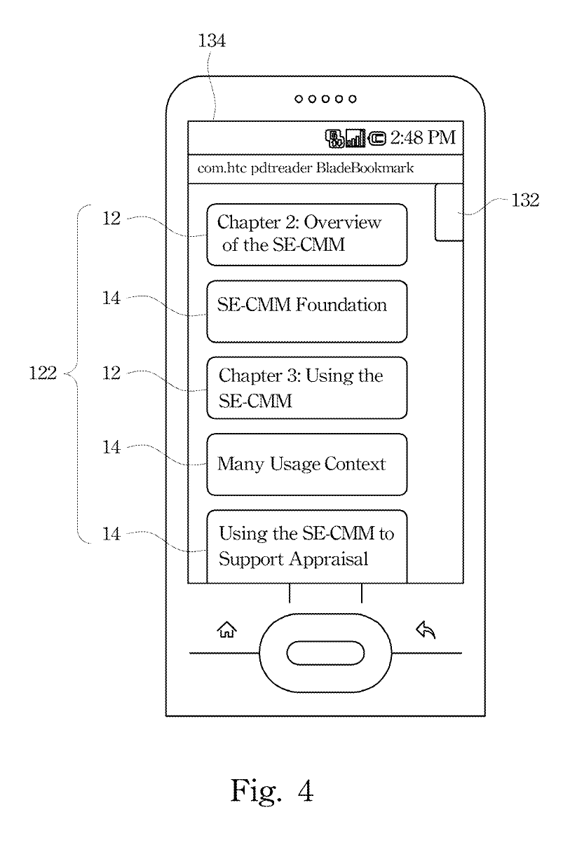

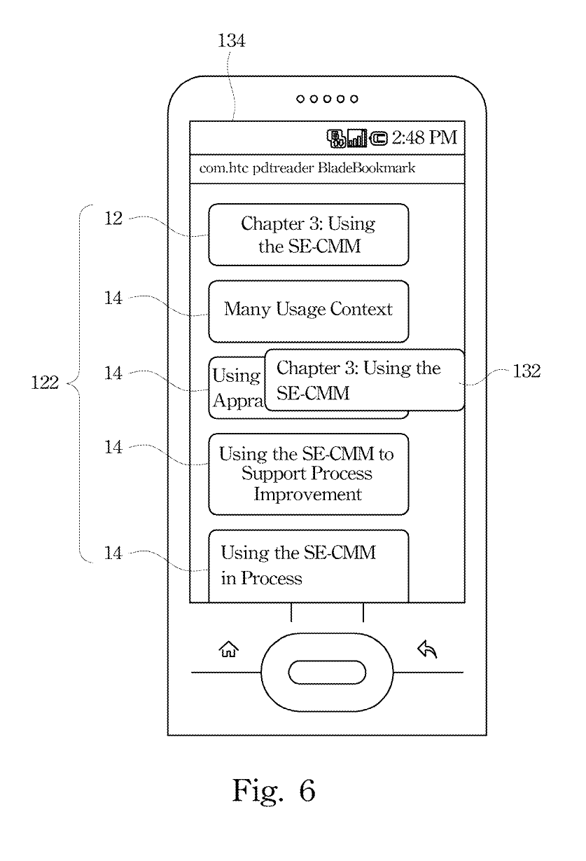

Refer to FIG. 3 and to FIG. 6 simultaneously. FIG. 3 is a flow chart showing an exemplary method 100 for displaying tree structure data. FIG. 4 to FIG. 6 are diagrams showing the screen of an exemplary hand-held electronic device.

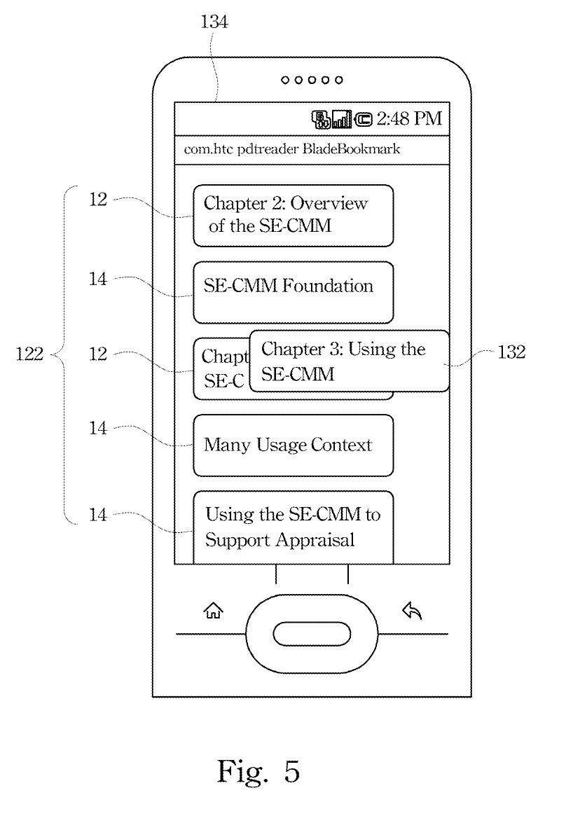

First consider the method 100 shown in the flow chart in FIG. 3. In Step 110 data is provided to the system to generate the function menu 10 with a tree structure form. In Step 120 the node items 12 and the sub-items 14 (see FIG. 4 to FIG. 6) are arranged in the line item 122. In step 130, a tag item 132 is provided. In step 140, at the least a portion of the item line 122 and the tag item 132 are displayed on the screen 134 (FIG. 4 to FIG. 6) of the hand-held electronic device, wherein the tag item 132 is movable when selected. As shown in FIG. 5, the tag item 132 is selected and moved down and the size thereof is enlarged to overlap the portion of the item line 122. At this time, if the distance between the tag item 132 and one of the node items 12 is smaller than a predetermined distance, or the tag item 132 overlaps one of the node items 12, the name of the one of the node items 12 is displayed on the screen, for example, displayed on or around the tag item 132. In the FIG. 5, the name of the node item 12 is displayed on the tag item 132.

In the FIG. 5, the name of the node item 12 overlapped by the tag item is “Chapter 3: Using the SE-CMM”, so the tag item 132 displays the name “Chapter 3: Using the SE-CMM” of the node item 12. In addition, in the FIG. 6, when the item overlapped by the tag item 132 is the sub-item 14, the tag item 132 displays the name of the tag item 132 including the sub-item 14 overlapped by the tag item 132. As shown in FIG. 6, the name of the sub-item 14 overlapped by the tag item 132 is “Using the SE-CMM to Support Appraisal”, and it belongs to the node item 12 named “Chapter 3: using the SE-CMM”, therefore the tag item 132 displays the name “Chapter 3: using the SE-CMM” of the node item 12.

In addition, when the tag item is moved up, the screen 134 scrolls up to display the other items of the item line 122 on the screen 134. In a similar way, when the tag item is moved down, the screen 134 scrolls down to display the other items of the item line 122 on the screen 134. Note that the scrolling of the screen 134 is configured to display the other items of the item line 122 on the screen 134, so, except for the items of the item line 122, the items displayed on the screen 134 may stay in their original place when the screen 134 scrolls up or down. For example, the time displayed on the upper right corner of the screen 134 stays at its original places, when the tag item 132 is moved up or down.

According to the aforementioned, the items of the function menu 10 are arranged in the item line 122, and the tag item 132 displays the name of the node item which the sub-item belongs to, and when the tag item 132 is moved, the screen 134 scrolls to display the other items of the item line 122. Because the screen 134 can be scrolled to display the option of the function menu 10, the size of the option icons do not have to be decreased to make all the options displayed on the screen. Furthermore, the name of the node item which the sub-item belongs to can be displayed on or around the tag item, so the user can quickly find the item he wants via the name displayed on the tag item.

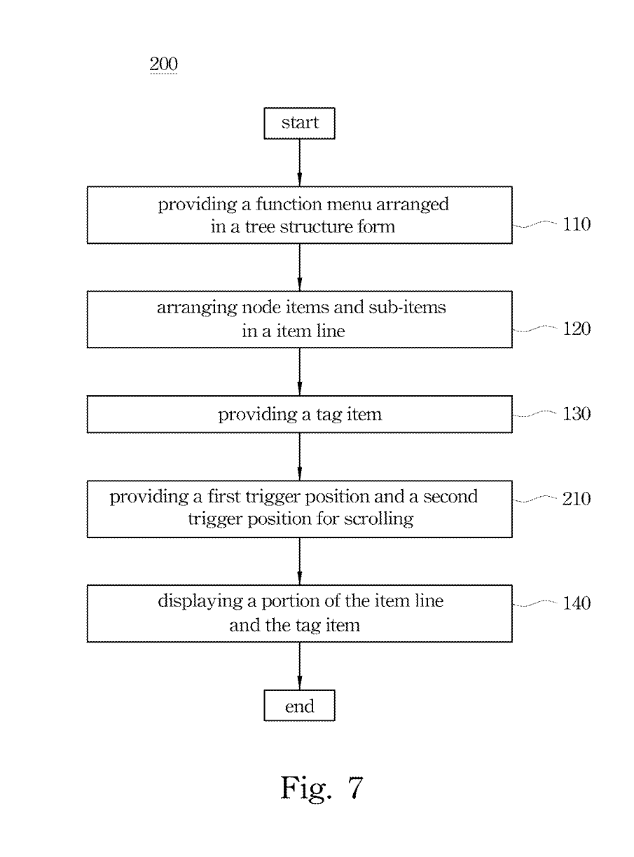

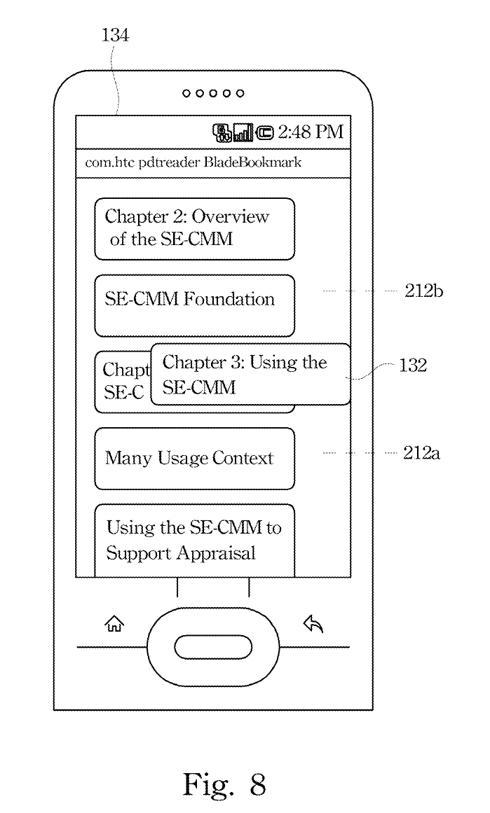

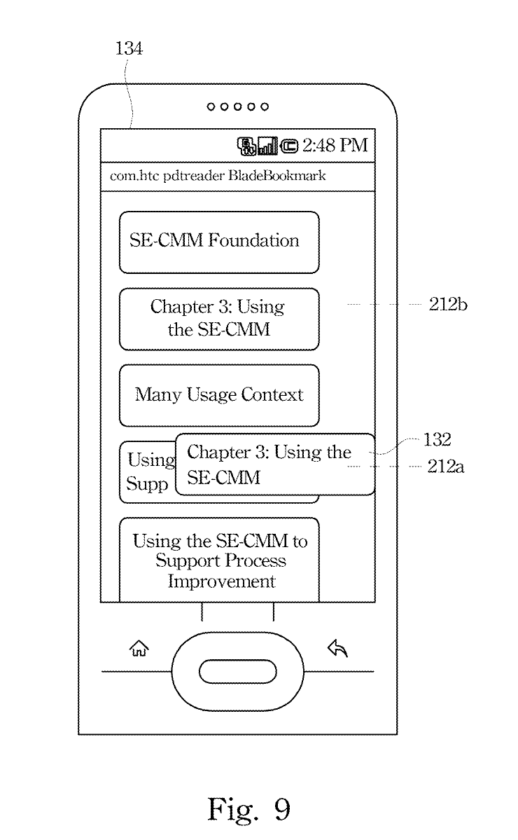

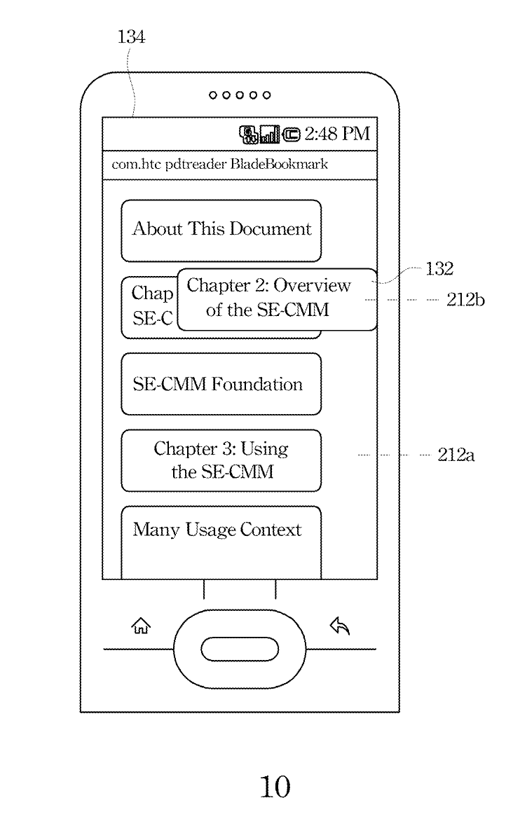

Refer to FIG. 7 to FIG. 10. FIG. 7 is a flow chart showing an exemplary method 200 for displaying tree structure data. FIG. 8 to FIG. 10 are diagrams showing a screen of an exemplary hand-held electronic device. The method 200 is similar to the method 100, but the difference is in that the method 200 further includes a trigger scrolling positions providing step 210. In the trigger scrolling positions providing step 210, trigger scrolling positions 212a and 212b are provided on the screen 134. When the tag item 132 is moved to the position 212a or 212b, the screen 134 starts to scroll.

As shown in FIG. 8, the tag item 132 initially overlaps the node item 12 named “Using the SE-CMM”. As shown in FIG. 9, when the tag item 132 is moved down to the position 212a, the screen 134 is then scrolled down until the tag item 132 leaves the position 212a, and thus the upper portion of the item line 122 is displayed on the screen 134.

According to the aforementioned, an exemplary method for triggering scrolling of the screen to match people's habit is provided.

In addition, the method 100 or 200 can be applied in a computer program product. When a computer (for example a processor of a mobile phone) loads the computer program product, it can perform the method 100 and 200 for displaying tree structure data.

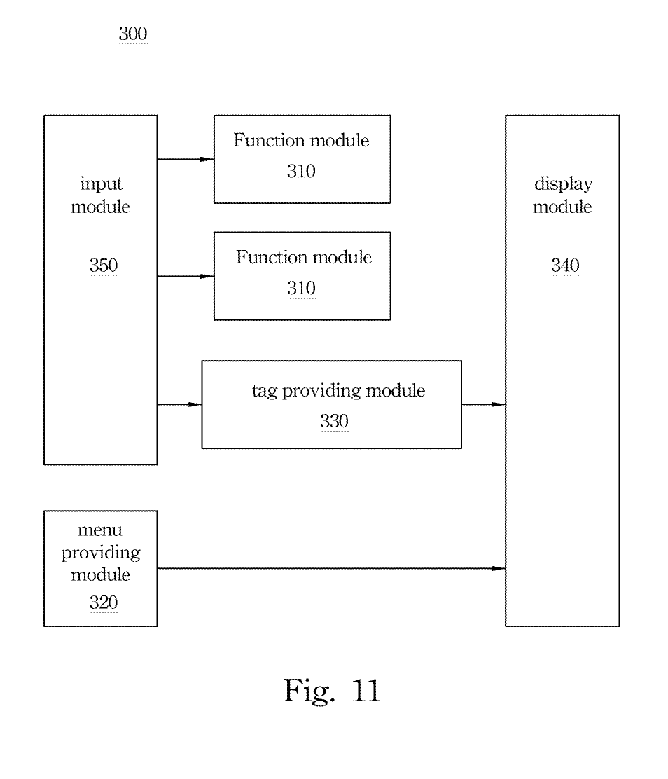

Refer to FIG. 4 to FIG. 6 and FIG. 11. FIG. 11 is a functional block diagram showing an exemplary hand-held electronic device 300. The hand-held electronic device 300 includes function modules 310, a menu providing module 320, a tag providing module 330, a display module 340, and an input module 350. The function modules 310 are used to provide various functions to users. For example, the function modules 310 may include a sound input module and a wireless communication module, wherein the sound input module is used to receive the sound messages of the users to output a sound information to the wireless communication module, and the wireless communication module is used to transmit a sound signal to a base station according to the sound information and receive another sound signal from the base station to enable the user to talk to a receiver. In other examples, the function modules can be camera modules or blue tooth communication modules.

The menu providing module 320 is used to provide the function menu 10 having the tree structure form and arrange node options (node items 12) and sub-options (sub-item 14) in a item line 122. The tag providing module 330 is used to provide and control the tag item 132. The display module 340 is used to display a portion of the item line 122 and the tag item 132 on the screen 134.

The input module 350 is used to be input a control signal by the user to control the function module 310 and the tag providing module 330. As shown in FIG. 4 and FIG. 6, when the user selects the tag item 132 via the input module 350, the tag providing module 330 makes the tag item 132 movable for the user and further enlarges the size of the tag item 132. When the tag item 132 is next to or overlaps on one of the node items 12 of the item line, the name of the one of the node items 12 is displayed on or around the tag item 132. When the tag item 132 is next to or overlaps on one of the sub-items 14 of the item line, the name of the node item which the one of the sub-items 14 belongs to is displayed on or around the tag item 132.

In addition, when the tag item 132 is moved up, the screen 134 scrolls up to display the other items of the item line 122 on the screen 134. In a similar way, when the tag item 132 is moved down, the screen 134 scrolls down to display the other items of the item line 134 on the screen.

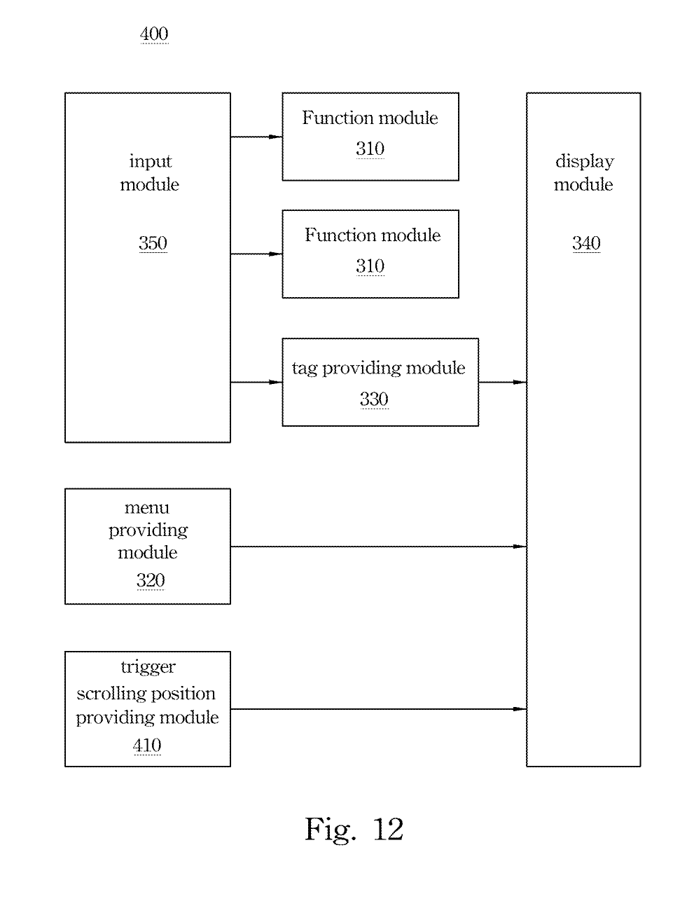

Refer to FIG. 8 to FIG. 10 and FIG. 12. FIG. 12 is a functional block diagram showing an exemplary hand-held electronic device 400. The hand-held electronic device 400 is similar to the hand-held electronic device 300, but the difference is in that the hand-held electronic device 400 further includes a trigger scrolling position providing module 410. The trigger scrolling position providing module 410 is used to provide the trigger scrolling positions 212a and 212b on the screen. When the user moves the tag item 132 to the trigger scrolling positions, the trigger scrolling position providing module 410 controls the menu providing module 320 to scroll the screen 134.

For example, as shown in FIG. 8, the tag item 132 initially overlaps the node item 12 named “Using the SE-CMM”. When the tag item 132 is moved down to the position 212a, as shown in FIG. 9, the screen 134 scrolls down until the tag item 132 leaves the position 212a, and thus the items of the lower half portion of the item line 122 is displayed. In a similar way, when the tag item 132 is moved up to the position 212b, as shown in FIG. 10, the screen 134 scrolls up until the tag item 132 leaves the position 212b, and thus the items of the upper half portion of the item line 122 is displayed.

In addition, it is noted that the input module 350 can be a touch detection module, such as a touch panel, a touch pad, and a trackball. When the user controls the touch detection module to touch the options displayed on the screen 134, the touch detection module controls (moves or selects) the items according to the motion (drawing or clicking) of the user.

As is understood by a person skilled in the art, the foregoing examples of the present disclosure are not a limitation. It is intended to cover various modifications and similar arrangements included within the spirit and scope of the appended claims, the scope of which should be accorded the broadest interpretation so as to encompass all such modifications and similar structures.

What is claimed is:

1. A method for displaying tree structure data, wherein the tree structure data comprises a node item and a sub-item belong to the node item, the method comprises:
displaying at least one portion of an item line including the sub-item and a tag item on a screen;
moving the tag item; and
displaying the name of the node item, when the tag item is next to the sub item.

2. The method of claim 1, further comprising displaying the name of the node item when the tag item is next to the node item, wherein item line further comprises the node item.

3. The method of claim 1, wherein the step for displaying the name of the node item on the screen comprises displaying the name of the node item on or around the tag item.

4. The method of claim 1, further comprising enlarging the size of the tag item when the tag item is moved.

5. The method of claim 1, further comprising scrolling the screen when the tag item is moved to a trigger position, to display another portion of the item line on the screen.

6. A computer program product, configured to be loaded by a computer to enable the computer to perform a method for displaying tree structure data, wherein the tree structure data comprises a node item and a sub-item belong to the node item, the method comprises:
displaying at least one portion of an item line including the sub-item and a tag item on a screen;
moving the tag item; and
displaying the name of the node item, when the tag item is next to the sub item.

7. The computer program product of claim 6, wherein the method further comprising displaying the name of the node item when the tag item is next to the node item, wherein item line further comprises the node item.

8. The computer program product of claim 6, wherein the step for displaying the name of the node item on the screen comprises displaying the name of the node item on or around the tag.

9. The computer program product of claim 6, wherein the method further comprising enlarging the size of the tag item when the tag item is moved.

10. The computer program product of claim 6, wherein the method further comprising scrolling the screen when the tag item is moved to a trigger position, to display another portion of the item line on the screen.

11. A hand-held electronic device, comprising:
a menu providing module, used to provide tree structure data, wherein the tree structure data comprises a node item and a sub-item belong to the node item;
a tag providing module, used to provide a tag item and move the tag item;
an input module, used to be inputted a control signal by a user to control the tag providing module, wherein the tag providing module moves the tag item in accordance with the control signal; and
a display module, used to display at least one portion of an item line comprising the node item and the sub-item on a screen;
wherein the screen displays the name of the node item when the user moves the tag item to an area next to the sub-item.

12. The hand-held electronic device of claim 11, wherein the item line further comprises the node item, and the screen displays the name of the node item when the tag item is next to the node item.

13. The hand-held electronic device of claim 11, wherein the name of the node item is displayed on or around the tag item.

14. The hand-held electronic device of claim 11, wherein the size of the tag item is enlarged when the tag item is moved.

15. The hand-held electronic device of claim 11, wherein a portion of the tag item overlaps a portion of the item line.

16. The hand-held electronic device of claim 11, wherein the screen scrolls to display another portion of the item line on the screen when the tag item is moved to a trigger position.

17. The hand-held electronic device of claim 11, wherein the input module is a touch detection module used to control the node item, the sub-item, or the tag item.

18. The hand-held electronic device of claim 11, further comprising a plurality of function modules used to provide a plurality of functions corresponding to the node item and the sub item in an one-to-one manner.

19. The hand-held electronic device of claim 18, wherein the function modules comprises:
a sound input module, used to input a sound message by a user to output a sound data;
a wireless communication module, used to transmit the sound data to a base station, and receive another sound data from the base station.

20. The hand-held electronic device of claim 11 is a personal digital assistant (PDA) or a mobile phone.
